(19) United States
(12) Patent Application Publication
(10) Pub. No.: US 2026/0348513 A1
(43) Pub. Date: Nov. 5, 2026

(54) A FRAME AND A STORAGE SYSTEM

(71) Applicant: ELFA INTERNATIONAL AB, VÄSTERVIK (SE)

(72) Inventors: Peter NILSSON, VÄSTERVIK (SE); Lars RYDÉN, VÄSTERVIK (SE)

(21) Appl. No.: 19/488,324

(22) PCT Filed: May 20, 2024
(86) PCT No.: PCT/SE2024/050481

§ 371 Date: Nov. 26, 2025

(30) Foreign Application Priority Data
May 26, 2023 (SE) 2350649-6

(51) Int. Cl. F16M 13/02; A47B 81/00

(52) U.S. Cl. CPC F16M 13/02; A47B 81/00

(57) ABSTRACT

The present disclosure relates to a frame (1, 3) for a storage system, the frame has a generally rectangular configuration with an open inner area (5) for taking up and carrying a container and lateral connection means (11) for connecting to a canti-levered bracket via a slider unit. The frame has a first part (1), comprising a rear leg (7) bent to form two lateral legs (9A, 9B) comprising the connection means and front end portions (21), and a second part (3) comprising a front bar, attached to said front end portions (21), wherein said first part (1) is formed from an elongated strip of metal comprising upper and lower flanges (13, 15) bent about the elongated axis of the strip and out of the plane of the strip to form an outwardly open channel (17) in the lateral legs.

### TECHNICAL FIELD

The present disclosure relates to a frame for a storage system. The frame has a generally rectangular configuration with an open inner area for taking up and carrying a container and lateral connection means for connecting to a cantilevered bracket or a wall in the storage system via a slider unit.

The present disclosure further considers a storage system comprising such a frame.

### BACKGROUND

Such frames are described for instance in WO-2017/171618-A1 where in a system the frame carries a container slideably arranged between two brackets to form a drawer.

One problem associated with storage systems of that type is how to utilize the available space in an efficient manner in order to increase the volume available for storage.

### SUMMARY

One object of the present disclosure is therefore to provide a frame that allows for efficient storage.

This object is achieved by a frame as defined in claim 1. More specifically, in a frame of the initially mentioned kind, there is provided a first part, comprising a rear leg bent to form two lateral legs comprising lateral connection means and front end portions, and a second part comprising a front bar, attached to said front end portions, wherein said first part is formed from an elongated strip of metal bent to form, in cross section, upper and lower flanges bent about the elongated axis of the strip and out of the plane of the strip to form an outwardly open channel in the lateral legs.

Such a frame will be relatively strong thanks to the flanges increasing the stiffness of the first part by being bent out of the plane of the strip. At the same time, the channel formed in the first part allows each of the lateral legs to more or less enclose a connected slider thereby allowing for an increased area available for a container inside the frame. This means that the available storage volume can be increased compared to a case where the slider would fully be stacked completely outside a frame part.

The front-end portions of the lateral legs may comprise tabs bent about an axis perpendicular to the elongated axis of the strip forming attachment surfaces, and the second part may be welded to the attachment surfaces.

A flange forming a horizontally directed ledge may be bent also in the front bar to make it stiffer.

The elongated strip may be bent to form a flat-top ridge projecting into the channel, and tabs may be provided on the ridge for connecting with a lateral slider. This facilitates the connecting to the slider as the tabs become easily accessible.

The present disclosure also considers a storage system with a frame as disclosed as disclosed above, and further comprising a first and a second slider configured to be connected to respective of said lateral legs, in the outwardly open channels.

### BRIEF DESCRIPTION OF THE DRAWINGS

FIG. 1 illustrates elements of a storage system frame interfacing with other components of a storage system interfacing with the storage system frame.

FIG. 2 shows a cross section through a main part of the frame in FIG. 1.

FIG. 3 shows a cross section through a front bar of the frame in FIG. 1.

FIG. 4 shows the finished frame with attached sliders.

FIG. 5 shows the assembly of FIG. 4 being fitted in a storage system.

FIG. 6 shows the storage system in FIG. 5 when assembled.

### DETAILED DESCRIPTION

The present disclosure relates a storage system, and more particularly a frame for a storage system. The storage system is typically of the kind where elongated hang standards are arranged vertically on a wall or the like, and the hang standard includes rows of slots by means of which, for instance, cantilevered brackets can be affixed to the to the hang standards. The brackets in turn can carry shelves or the like. WO-2017/171618-A1 illustrates such a system where further a drawer can be slideably arranged between two brackets. The drawer may comprise for instance a wire basket placed in a frame which is connected to left and right brackets by means of a slider unit. The present disclosure is concerned with providing an improved robust frame for such a system which allows more efficient storage of items in a container disposed in the frame. This frame could also be used in for instance a cupboard where the sliders are attached to inner walls thereof.

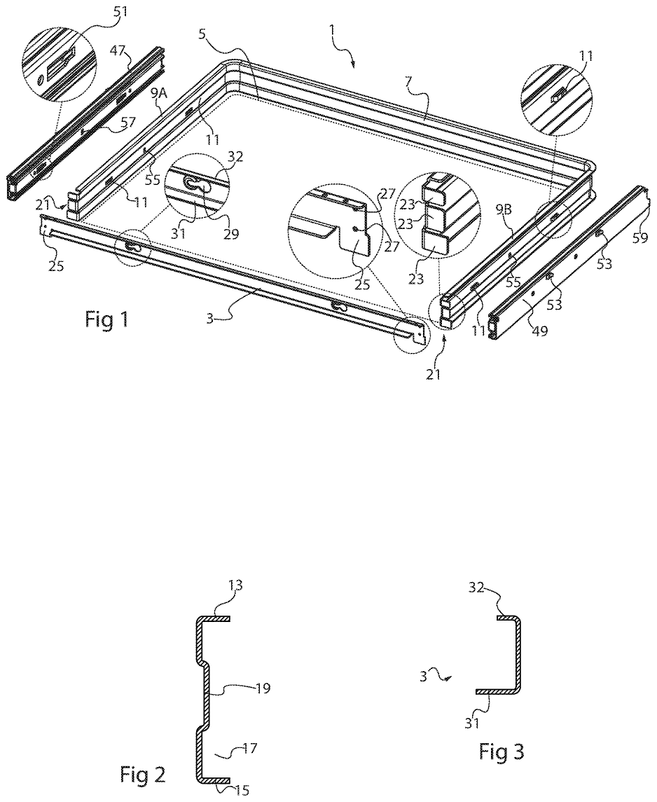

FIG. 1 illustrates a frame according to an example of the present disclosure that is not yet assembled or connected to parts with which it interfaces.

The frame comprises a first 1 and a second 3 part, which are to be assembled to form a rectangular configuration with an open inner area 5 for taking up and carrying a container (not shown). The first part 1 comprises a rear leg 7 bent to form two lateral legs 9A, 9B, which comprise connection means, for instance as illustrated in the form of punched-out tabs 11, adapted to connect with slider units 47, 49 as will be discussed.

The first part 1 may be formed from an elongated strip of metal which may have a more or less uniform cross section along its length with, as illustrated in FIG. 1, exceptions at the location of the tabs 11 and at the ends of the strip, as will be shown.

The strip, for instance made of carbon steel-may be roll-shaped into this cross section as illustrated in FIG. 2. The strip then comprises upper 13 and lower 15 flanges bent about the elongated axis of the strip and out of the plane of the strip to form an outwardly open channel 17 in the lateral legs 9A, 9B as well as the rear leg 7.

Further, there may be formed a ridge 19 with a flat top projecting from the web of the strip into this channel 17.

By forming a cross section with the upper and lower flanges 13, 15, the frame as a whole becomes more rigid, and forming the outwardly open channel 17 provides room for a slider unit 47, 49 which makes better use of the available distance between two brackets such that a more efficient storage space is maintained. The ridge 19 make the connection means 11 reach into the channel 17 to provide good contact with a slider unit 47, 49 as will be discussed.

The lateral legs 9A, 9B further comprise front end portions 21 for connecting with the second part of the frame in the form of a front bar 3, which is attached to the front-end portions 21.

The front-end portions 21 of the lateral legs comprise tabs 23 bent about an axis perpendicular to the elongated axis of the strip, thereby forming attachment surfaces for the ends 25 of the front bar 3. Those ends 25 may be spot welded to one or more of the tabs 23, and holes 27 may be provided in the front bar 3 at the ends 25 to facilitate the welding.

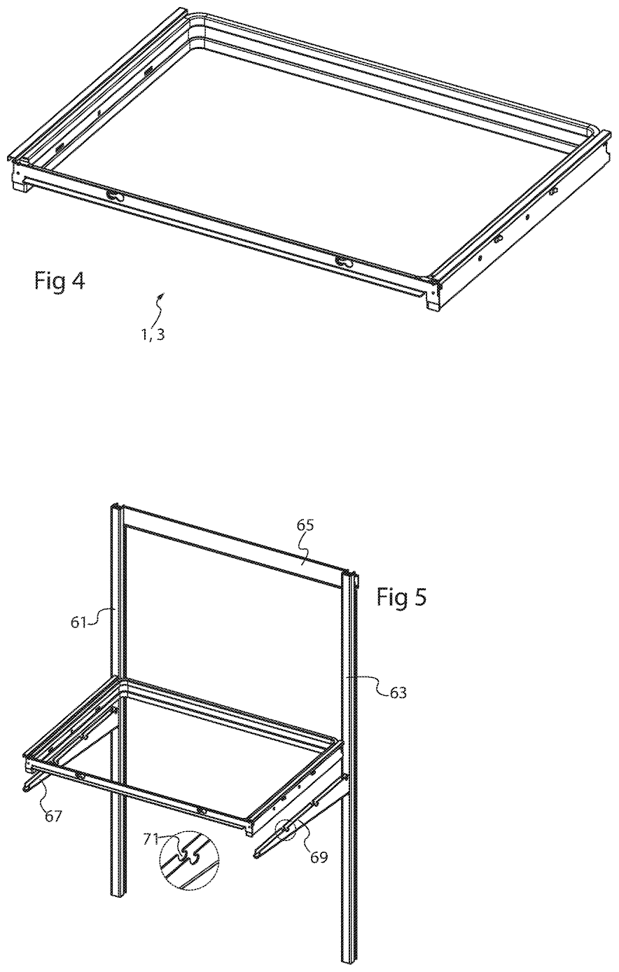

As shown in FIG. 1, the front bar 3 may comprise key-slot holes 29 for facilitating the attachment of a facia or other decorative element on the front bar 3, if desired. There may also be provided a ledge 31 at the bottom section of the front bar 3, as seen in the cross section of FIG. 3, also presenting a top ledge 32. The ledges 31, 32 make the front bar 3 stiffer.

Returning to FIG. 1, the front bar 3 is attached to the lateral legs 9A, 9B of the first part 1 to form the finished frame typically by spot-welding. In the following it is described how this frame interfaces with other parts of the storage system.

The left and right sliders 47, 49 are attached in the left and right 9A, 9B lateral legs, respectively, of the first frame part 1. As shown on the left side, the inside of the sliders 47 may comprise slots 51 configured to connect with the tabs 11 of the lateral leg to lock the slider 47 inside the outwardly open channel 17 formed in the lateral leg 9A as best seen on the right side. When the tabs 11 are fully inserted in the slots 51, a bead 55 on the outer side of the lateral legs 9A, 9B may snap into a hole 57 in the slider 47. This keeps the slider 47 firmly connected to the frame 1, 3.

When the front bar 3 is attached to the part 1 to form the finished frame 1, 3, and the sliders 47, 49 are attached thereto, this assembly is configured as shown in FIG. 4. If desired, this frame 1, 3 may be provided with decorative fascia or trims at the front bar 3 and on top of the side portions 9A, 9B.

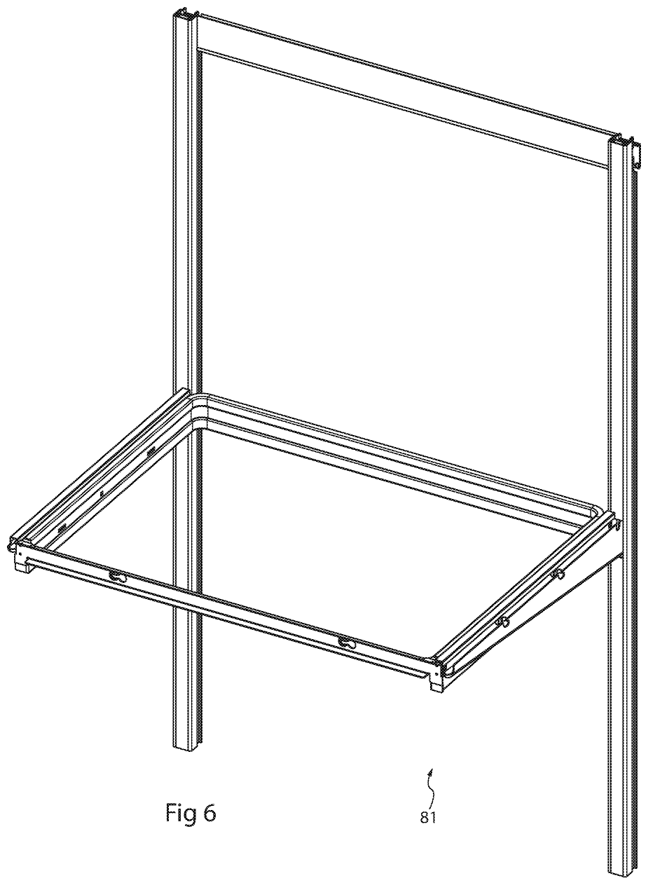

Returning to FIG. 1, the left and right sliders 47, 49 may further comprise outer tabs 53, as best seen on the slider 49 on the left side, which are configured to be connected for instance to cantilevered brackets similarly to what is described in WO-2017/171618-A1, for instance. This is illustrated in an example in FIG. 5 where a storage system comprises a first and a second hang standard 61, 63 which are suspended from a rail 65 attached to a wall or the like. The hang standards 61, 63 comprise rows of slots (not shown) in their front surfaces where, for instance, brackets 67, 69 may be attached as shown. The assembly of FIG. 4 is attached in between the brackets 67, 69 using the tabs 53 of the sliders 47, 49 (cf. FIG. 1) which are inserted into slots 71 on the sides of the brackets 67, 69.

It would also be possible to attach the sliders on inner walls of a cupboard for instance. This can be done with screws that firmly attach the stationary part of the slider to said walls. The present frame can therefore be used also outside a context with brackets attached to hang standards.

When attached, the storage system 81 is as shown in FIG. 6 only lacking a container such as a wire-or mesh basket or plastic container to be inserted in the frame 1, 3.

Then the container with the frame can be drawn out of the storage system 81 with the sliders 47, 49 extending, i.e. their outer parts connecting to the brackets and their inner parts sliding with the frame. As shown in FIG. 1, each slider may be provided with a rear tab 59 that can extend into a slot of a hang standard 61, 63, preventing that the frame 1, 3 tips forwards when its mass centre is moved out of the area in between the brackets 67, 69. This function may be acheived in other ways.

The present disclosure is not restricted to above illustrated examples and may be varied and altered in different ways within the scope of the appended claims. For instance, other attachment means than tabs and slots may be provided on the lateral legs and the sliders, and for instance the sliders and slots may switch places.

1. A frame for a storage system, the frame having a generally rectangular configuration with an open inner area for taking up and carrying a container and lateral connection means for connecting to a cantilevered bracket or a wall via a slider unit, characterized by a first part, comprising a rear leg bent to form two lateral legs comprising connection means at front end portions, and a second part comprising a front bar, attached to said front end portions, wherein said first part is formed from an elongated strip of metal comprising upper and lower flanges bent about the elongated axis of the strip and out of the plane of the strip to form an outwardly open channel in the lateral legs.

2. The frame according to claim 1, wherein the front-end portions of the lateral legs comprise tabs bent about an axis perpendicular to the elongated axis of the strip forming attachment surfaces and wherein the second part is welded to the attachment surfaces.

3. The frame according to claim 2, wherein a flange forming a horizontally directed ledge is formed in the front bar.

4. The frame according to claim wherein the elongated strip is bent to form a flat-top ridge projecting into said channel.

5. The frame according to claim 4, wherein tabs are provided on said ridge for connecting with a lateral slider.

6. (canceled)

7. The frame according to claim 2, wherein the elongated strip is bent to form a flat-top ridge projecting into said channel.

8. The frame according to claim 7, wherein tabs are provided on said ridge for connecting with a lateral slider.

9. The frame according to claim 3, wherein the elongated strip is bent to form a flat-top ridge projecting into said channel.

10. The frame according to claim 9, wherein tabs are provided on said ridge for connecting with a lateral slider.

11. A storage system comprising:
a frame having a generally rectangular configuration with an open inner area for carrying a container, the frame comprising a first part and a second part;
wherein the first part of the frame comprises an elongated strip of metal bent to form to form a rear leg and two lateral legs, the two lateral legs each having upper and lower flanges forming an outwardly open channel in the lateral legs, the upper and lower flanges formed by bending the elongated strip about its elongated axis and out of plane of the strip; and
wherein the second part comprises a front bar connected to the front end portions of the lateral legs;
the storage system further comprising a first and a second slider configured to be connected to respective of said lateral legs, in said outwardly open channels.

12. The storage system according to claim 11, wherein the front-end portions of the lateral legs comprise tabs bent about an axis perpendicular to the elongated axis of the strip forming attachment surfaces and wherein the second part is welded to the attachment surfaces.

13. The storage system according to claim 12, wherein the elongated strip is bent to form a flat-top ridge projecting into said channel.

14. The storage system according to claim 13, wherein tabs are provided on said ridge for connecting with a lateral slider.

15. The storage system according to claim 12, wherein a flange forming a horizontally directed ledge is formed in the front bar.

16. The storage system according to claim 15, wherein the elongated strip is bent to form a flat-top ridge projecting into said channel.

17. The storage system according to claim 16, wherein tabs are provided on said ridge for connecting with a lateral slider.

18. The storage system according to claim 11, wherein the elongated strip is bent to form a flat-top ridge projecting into said channel.

19. The storage system according to claim 18, wherein tabs are provided on said ridge for connecting with a lateral slider.
